(19) United States
(12) Patent Application Publication
(10) Pub. No.: US 2013/0107003 A1
(43) Pub. Date: May 2, 2013

(54) APPARATUS AND METHOD FOR RECONSTRUCTING OUTWARD APPEARANCE OF DYNAMIC OBJECT AND AUTOMATICALLY SKINNING DYNAMIC OBJECT

(71) Applicant: Electronics and Telecommunications Research, Daejeon (KR)

(72) Inventors: Seong Jae LIM, Daejeon (KR); Hanbyul JOO, Daejeon (KR); Ji Hyung LEE, Daejeon (KR); BONKI KOO, Daejeon (KR)

(73) Assignee: Electronics and Telecommunications Research Institute, Daejeon (KR)

(21) Appl. No.: 13/649,092

(22) Filed: Oct. 10, 2012

(30) Foreign Application Priority Data
Oct. 31, 2011 (KR) 10-2011-0112068

(51) Int. Cl. G06T 15/00

(52) U.S. Cl. 348/46; 348/E13.074

(57) ABSTRACT

An apparatus for reconstructing appearance of a dynamic object and automatically skinning the dynamic object, includes an image capturing unit configured to generate a multi-view image and multi-view silhouette information of a dynamic object and a primary globally fitted standard mesh model; and a 3D image reconstruction unit configured to perform global and local fitting on the primary globally fitted standard mesh model, and then generate a Non Uniform Rational B-Spline (NURBS)-based unique mesh model of the dynamic object. Further, the apparatus includes a data output unit configured to generate and output a final unique mesh model and animation data based on the NURBS-based unique mesh model of the dynamic object and at least two pieces of operation information about the dynamic object.

### CROSS-REFERENCE TO RELATED APPLICATION(S)

The present invention claims priority of Korean Patent Application No. 10-2011-0112068, filed on Oct. 31, 2011, which is incorporated herein by reference.

### FIELD OF THE INVENTION

The present invention relates to the reconstruction of the appearance of a dynamic object; and more particularly, to an apparatus and method for reconstructing the appearance of a dynamic object and automatically skinning the dynamic object, which is capable of reconstructing the appearance of a dynamic object captured from multi-view images taken by a single image capturing camera and multi-view stereo images, without requiring geometric calibration, and is capable of automatically transferring the shape of a standard mesh model and performing parametric control on the standard mesh model so that the realistic animation of a reconstructed three-dimensional (3D) mesh model is realized, and which is capable of being applied to heterogeneous animation engines.

### BACKGROUND OF THE INVENTION

Generally, conventional technologies that capture the appearance information of a dynamic object include a method that generates a three-dimensional (3D) model by scanning the static appearance information of the object using an active sensor such as a laser or a pattern light, and a method of generating a 3D model by reconstructing the 3D model based on various reconstruction methods using image information received from various cameras. However, there are disadvantages in the conventional technologies that the appearance of a 3D model reconstructed using various reconstruction methods is a volume model, the shape of which is not able to being transformed, or the appearance is neither natural nor realistic, so that the appearance of the 3D model needs to be post-processed by experts such as skilled designers. There are additional disadvantages because a plurality of cameras need to be used, creating the problems of synchronization between the cameras, color consistency (photo-consistency), and geometric calibration. Furthermore, in order to animate the 3D models reconstructed by the above methods depending on the motions of the dynamic object, a skeletal structure capable of transforming the shape and incorporating motion information needs to be generated, and the appearance needs to be bound to the generated skeletal structure using suitable weights.

Conventional object model generation techniques generate a stick model that is obtained by modeling only an initial skeleton, a surface model that represents the appearance of an object using surface patches, and a volume model that configures an object using a combination of a sphere, a cylinder, an ellipsoid, and the like. However, these models are problematic in that it is difficult to represent the appearance realistically, shape transformation based on motions is unnatural, a lot of time is required to transform the shape, or the manual operation of a user, such as a professional designer, is required.

Recently, a muscle simulation model incorporating anatomical features, and an interactive linear combination skinning model based on example data having a skeleton and mesh structure, have been proposed. These models enable relatively realistic shape transformation to be performed, but there are problems. These problems are that it is difficult to perform shape transformation in real time and to produce such a model due to limited computation speed, and that the precision of the generated animation depends on the accuracy of previously produced models and the degree of combination of these models, and deformation artifacts such as a ‘candy-wrapper’ appear on the principal joints.

Furthermore, there is a technique for attaching markers to the appearance of a dynamic object, obtaining position information about the markers using a motion capturing device, and reconstructing the appearance of the dynamic object using an optimization technique that minimizes a difference between the markers corresponding to a standard mesh model. However, this technique is problematic in that a larger number of markers need to be attached to the appearance of the dynamic object, an expensive motion capturing device needs to be provided, a manual operation needs to be performed to find the markers corresponding to the standard mesh model, and above all, the pose and shape of the standard mesh model need to be similar to those of the dynamic object.

In conventional model transfer techniques, a method of transferring and reusing geometrically similar mesh regions in a previous frame of the same model or in different models has been proposed. However, this method is problematic in that such model transfer is the transfer of the partial appearance of a 3D model, and the skeletal structure is not transferred, thus allowing a designer to generate a skeletal structure to perform animation.

Further, a technique for transferring the skeletal structure of a standard model into a target model, and enabling it to make motions has been proposed. However, this is problematic in that the target model needs to be a mesh model identical to the standard model.

### SUMMARY OF THE INVENTION

In view of the above, the present invention provides an apparatus and method which is capable of generating a unique mesh model enabling free and realistic shape transformation of a dynamic object and also enabling the animation of the dynamic object via only a single image capturing camera using multi-view image information containing only the appearance information of the dynamic object, without requiring geometric calibration.

Further, the present invention provides an apparatus and method which is capable of automatically generating a more realistic unique mesh model by incorporating the appearance characteristics of a standard mesh model so that the unique appearance characteristics of each object may be realistically represented, and that may automatically rig and generate a hierarchical joint-skeleton structure capable of implementing natural and realistic unique dynamic motions by transferring the skeletal structure of the dynamic object into a standard mesh model having a hierarchical joint structure.

Furthermore, the present invention provides an apparatus and method for reconstructing the appearance of a dynamic object and automatically skinning the dynamic object, which are able to guaranteeing real-time properties and compatibility with commercial engines while reproducing realistic and natural appearance transformation properties without change or in an improved manner.

In accordance with a first aspect of the present invention, there is provided an apparatus for reconstructing appearance of a dynamic object and automatically skinning the dynamic object, including: an image capturing unit configured to generate a multi-view image and multi-view silhouette information of a dynamic object and a primary globally fitted standard mesh model, based on images obtained by capturing the dynamic object and a standard mesh model; a three-dimensional (3D) image reconstruction unit configured to perform global and local fitting on the primary globally fitted standard mesh model based on the multi-view image and the multi-view silhouette information of the dynamic object, and then generate a Non Uniform Rational B-Spline (NURBS)-based unique mesh model of the dynamic object; and a data output unit configured to generate and output a final unique mesh model and animation data based on the NURBS-based unique mesh model of the dynamic object and at least two pieces of operation information about the dynamic object.

The image capturing unit may generate the multi-view image covering a circumference of the dynamic object, the silhouette information about the multi-view image, and the primary globally fitted standard mesh model using a method of extracting silhouette information of a front view based on a front view image of the dynamic object captured by a camera, performing global fitting on the standard mesh model based on the silhouette information of the front view, receiving an image of a subsequent view by changing a capturing angle of the camera, extracting silhouette information of the subsequent view, and performing global re-fitting on the globally fitted standard mesh model based on the silhouette information of the subsequent view.

Further, the image capturing unit may control the capturing angle of the camera such that the capturing angle of the camera is changed at intervals of 90°.

The primary globally fitted standard mesh model may be a standard mesh model fitted to silhouette information extracted from front and side view images of the multi-view image.

Further, the 3D image reconstruction unit may separate a portion corresponding to an object region from each image of the multi-view image as a foreground, reconstruct a geometric shape of a 3D appearance of the dynamic object into a 3D volume model or point model of the dynamic object based on a volume defined as voxels or based on points of the dynamic object present in a 3D space, using foreground region information of the camera and color information in the foreground, and may generate a NURBS-based rigged unique mesh model of the dynamic object using the reconstructed 3D volume model or point model.

The 3D image reconstruction unit may be configured to: detect 3D landmarks from the reconstructed 3D volume model, and generate a hierarchical joint structure of the reconstructed 3D volume model, perform global fitting on the primary globally fitted standard mesh model by performing scaling and fitting on each joint using the hierarchical joint structure of the reconstructed 3D volume model and parameters of the primary globally fitted standard mesh model, extract feature points of the 3D volume model using the hierarchical joint structure of the reconstructed 3D volume model, and extract representative feature points of the 3D volume model using representative feature points of the primary globally fitted standard mesh model and the extracted feature points, perform local fitting on the primary globally fitted standard mesh model, on which the global fitting has been performed, using the representative feature points of the primary globally fitted standard mesh model, on which the global fitting has been performed, and the representative feature points of the 3D volume model, thus transferring the appearance, and generate a NURBS-based rigged unique mesh model of the dynamic object by applying color information to a result of the appearance transfer.

Further, the 3D image reconstruction unit may extract features points for respective regions based on about color and silhouette information in the multi-view image and information about surface voxels having photo-consistency equal to or greater than a preset value, among surface voxels of the reconstructed 3D volume model, separate regions using connectivity between the surface voxels and rigid/non-rigid properties of the surface voxels, and then detect 3D landmarks corresponding to the extracted feature points and rigid/non-rigid boundaries.

Further, the 3D image reconstruction unit may generate the hierarchical joint structure using sections generated based on normal vectors of voxels within the reconstructed 3D volume model or may generate the hierarchical joint structure using skeleton information obtained by skeletonizing the 3D volume model based on distance conversion of the 3D volume model and skeleton information obtained using the sections.

The data output unit may transform the NURBS-based unique mesh model of the dynamic object based on the operation information, re-represent transformed appearance information using a joint-virtual joint-vertex skinning technique, calculate joint-virtual joint-vertex skinning information by comparing the transformed appearance information with the re-represented appearance information for each piece of operation information, and then generate the animation data and the final unique mesh model using the joint-virtual joint-vertex skinning information.

As described above, in accordance with embodiments of the present invention, a unique mesh model can be automatically generated which enables free and realistic shape transformation of a dynamic object and also enables the animation of the dynamic object via only a single image capturing camera using multi-view image information containing only the appearance information of the dynamic object, without requiring geometric calibration.

Further, it is possible to automatically generate a more realistic unique mesh model by incorporating the appearance characteristics of a standard mesh model so that the unique appearance characteristics of each object can be realistically represented, and it is possible to automatically rig and generate a hierarchical joint-skeleton structure capable of implementing natural and realistic unique dynamic motions by transferring the skeletal structure of the dynamic object into a standard mesh model having a hierarchical joint structure, thus guaranteeing real-time properties and also guaranteeing compatibility with commercial engines while reproducing the properties of realistic and natural transformation of the appearance without change or in an improved manner.

### BRIEF DESCRIPTION OF THE DRAWINGS

The objects and features of the present invention will become apparent from the following description of embodiments given in conjunction with the accompanying drawings, in which:

FIG. 1 is a block diagram showing an apparatus for reconstructing the appearance of a dynamic object and automatically skinning the dynamic object in accordance with an embodiment of the present invention;

FIG. 2 is a flow chart showing a procedure in which an image capturing unit is operated using images received from a single camera in accordance with the embodiment of the present invention;

FIG. 3 is a flow chart showing the procedure of generating an appearance NURBS surface-based standard mesh model for transferring a mesh model having a skeletal structure that enables shape transformation and animation;

FIG. 4 is a flow chart showing the operating procedure of a 3D image reconstruction unit in accordance with the embodiment of the present invention;

FIG. 5A is a diagram showing feature points extracted from a 3D volume model reconstructed from multi-view images according to an embodiment of the present invention;

FIG. 5B is a diagram showing the extraction of representative feature point shown in FIG. 5A;

FIG. 6 is a flow chart showing the operating procedure of a skin data output unit in accordance with the embodiment of the present invention;

FIG. 7 is a diagram showing the appearance NURBS surfaces of a standard mesh model, skin vertices indicative of the appearance of the model, and a displacement between the NURBS surfaces and the appearance unit in accordance with the present invention; and

FIG. 8 is a diagram showing the procedure of generating an appearance NURBS surface-based standard mesh model for transforming a mesh model having a skeletal structure that enables shape transformation and animation.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

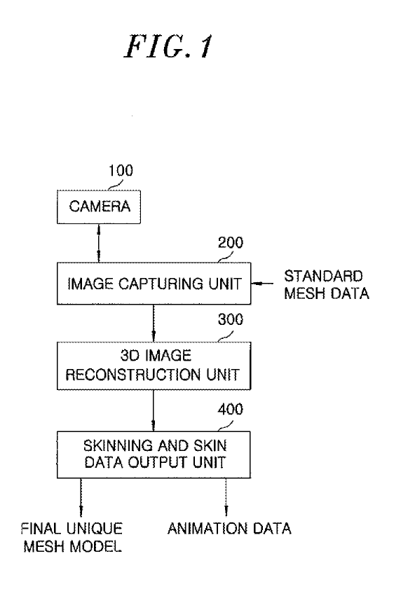

FIG. 1 is a block diagram showing an apparatus for reconstructing the appearance of a dynamic object and automatically skinning the dynamic object in accordance with an embodiment of the present invention.

As shown in FIG. 1, an apparatus for reconstructing the appearance of a dynamic object and automatically skinning the dynamic object in accordance with an embodiment of the present invention includes a camera 100, an image capturing unit 200, a 3D image reconstruction unit 300, and a skinning and skin data output unit 400.

The image capturing unit 200 may receive images captured by the camera 100, i.e., a dynamic object to be reconstructed and a standard mesh model, and generate and output multi-view images, silhouettes, and a globally fitted standard mesh model.

The image capturing unit 200 in accordance with the embodiment of the present invention may globally fit the mesh and skeletal structures of a standard mesh model to the dynamic object in conformity with the appearance characteristics of the dynamic object using silhouette information of a specific view of the dynamic object captured by the single camera 100, and may generate images of other views using the globally fitted standard mesh model and the silhouette information of the specific view as a guideline. That is, the image capturing unit 200 may generate multi-view images and the silhouette information of the multi-view images by using the silhouette information of the specific view as a guideline, and may globally fit the mesh and skeletal structures of the standard mesh model in conformity with the appearance characteristics of the dynamic object based on the silhouette information.

In accordance with the embodiment of the present invention, since only the single camera 100 is used, there is no need to calculate internal factors to make a geometric calibration and to implement photo-consistency. Further, a distance and a direction very similar to those of a previous view may be set by using the 3D mesh model roughly fitted to the dynamic object and the silhouette information of an immediately previous view as a guideline, so that there is no need to calculate even external factors to make a geometric calibration.

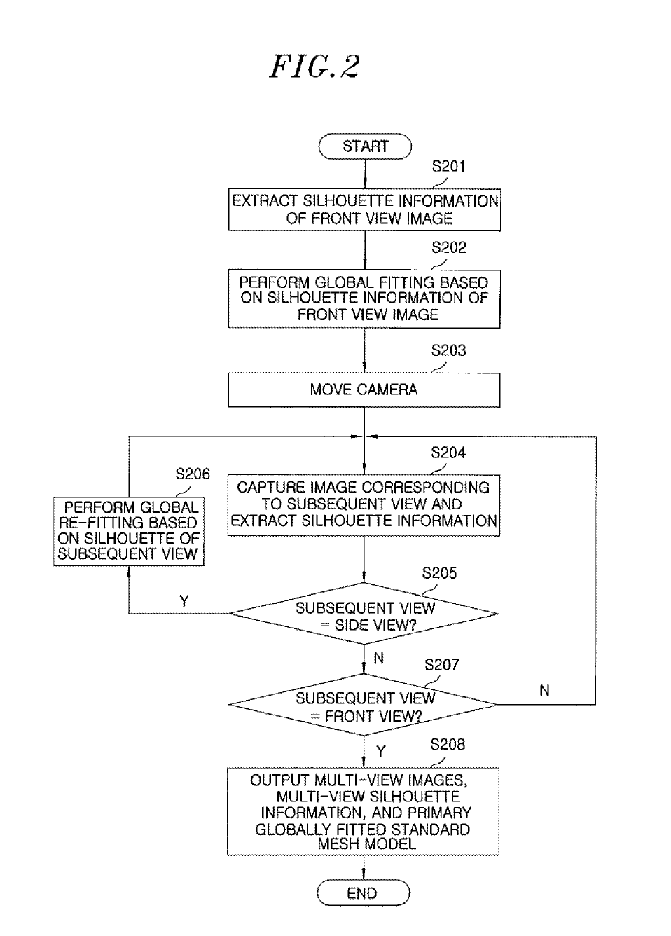

Such an image capturing unit 200 will be described below with reference to FIG. 2.

FIG. 2 is a flow chart showing a procedure in which the image capturing unit is operated using images received from a single camera according to an embodiment of the present invention.

As shown in FIG. 2, in step S201, the image capturing unit 200 may receive a front-view image of a dynamic object from the camera 100, and may extract silhouette information of the front view from the front-view image. Thereafter, in step S202, the image capturing unit 200 may extract parameters, such as the approximate joint positions, heights, and widths of the dynamic object, from the extracted silhouette information, and may perform the global fitting procedure of fitting the standard mesh model to the extracted parameters by controlling the skeleton of the standard mesh model and the NURBS surfaces, to which skin vertices are bound.

Thereafter, in step S203, the image capturing unit 200 may set the roughly fitted appearance information of the standard mesh model, obtained by globally fitting the standard mesh model to the extracted silhouette information of the front view, as a guideline, and may move the camera 100 at an angle corresponding to a subsequent view. Next, in step S204, the image capturing unit 200 may capture an image corresponding to the subsequent view using the camera 100, and may extract silhouette information about the image corresponding to the subsequent view.

In step S205, the image capturing unit 200 may determine whether the view of the captured image is a side view (90°). If it is determined in step S205 that the view of the captured image is the side view, the procedure of globally fitting the fitted standard mesh model may be re-performed based on silhouette information of the side view in step S206, thus rendering an improvement such that the appearance of the standard mesh model further resembles that of the dynamic object.

The above-described steps are repeatedly performed until the initial front view appears, so that multi-view images covering the overall circumference of the dynamic object, multi-view silhouette information, and a standard mesh model, roughly fitted to front and side view silhouette information, may be obtained. Specifically, if it is determined in step S205 that the captured view is not a side view, the image capturing unit 200 may determine whether the captured view is a front view in step S207. If it is determined in step S207 that the captured view is not a front view, the control step goes back to step S204 to perform subsequent steps. On the other hand, if it is determined in step S207 that the captured view is the front view, multi-view images covering the overall circumference of the dynamic object, multi-view silhouette information, and a standard mesh model that has been roughly fitted to front and side view silhouette information, i.e., a primary globally fitted standard mesh model, are generated in step S208. The multi-view images, the multi-view silhouette information, and the primary globally fitted standard mesh model, which have been generated in this way, may be provided to the 3D image reconstruction unit 300.

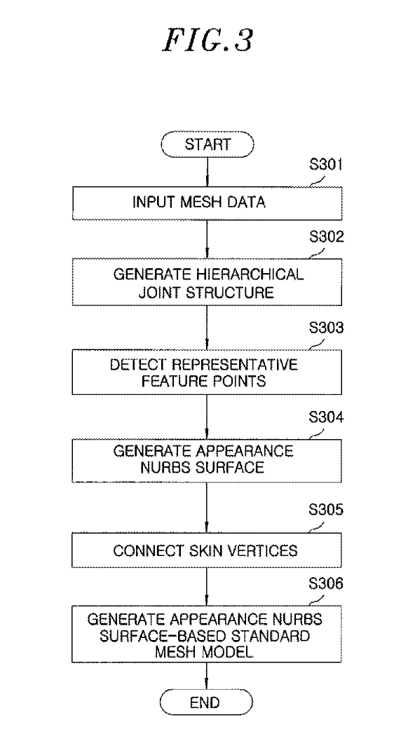

Further, the standard mesh model input to the image capturing unit 200 in accordance with an embodiment of the present invention may be an appearance NURBS surface-based standard mesh model for transforming a mesh model having a skeletal structure that enables shape transformation and animation. The procedure of generating such a standard mesh model will be described below with reference to FIG. 3.

FIG. 3 is a flow chart showing the procedure of generating an appearance NURBS surface-based standard mesh model for transferring a mesh model having a skeletal structure that enables shape transformation and animation.

As shown in FIG. 3, given scan data or mesh data provided for an existing 3D mesh object model is input in step S301, and a skeletal structure is generated using the input mesh data while a hierarchical joint structure having a total of n number of joints is generated using the spine of the trunk as a root and using principal joining parts for respective regions (regions of shoulders, wrists, pelvis, and ankles) as sub-roots in step S302.

Next, in step S303, representative feature points are extracted from locations between the generated joints at which the appearance of the model can be desirably represented. In step S304, sections may be set at locations where the appearance of the model may be desirably represented, a center position may be calculated from a set of vertices of the mesh model present on each section, and 1 number of vertices present at regular intervals around the center position may be found and may set the found vertices as key vertices of the section, so that B-spline interpolation may be performed on the key vertices to generate key section curves, and the generated key section curves may be interpolated for respective regions of the object, and then appearance NURBS surfaces may be generated. A dependency on displacements between the generated NURBS surfaces and the individual vertices of the input mesh model is set up, so that the appearance NURBS surface-based standard mesh model may be generated by connecting the generated NURBS surfaces to the skin vertices of the input mesh model in steps S305 and S306. The appearance NURBS surface-based standard mesh model generated in this way may transform the appearance of the model naturally and realistically using u direction curves generated in such a way as to perform B-spline interpolation on key vertices corresponding to each of the key section curves as edit points, using a uv-map generated in a v direction, using the height parameters of the knot vectors of the muscle surfaces of each region when a specific pose, e.g., a folded, swollen or projected pose, is taken, and using a weighted-sum between the displacements of key vertices.

Further, the multi-view images and the multi-view silhouette information of the dynamic object and the primary globally fitted standard mesh model, which have been generated by the image capturing unit 200 according to an embodiment of the present invention, may be input to the 3D image reconstruction unit 300. The 3D image reconstruction unit 300 may perform global and local fitting on the primary globally fitted standard mesh model based on the multi-view images and the multi-view silhouette information of the dynamic object, thus generating the NURBS-based unique mesh model of the dynamic object.

That is, the 3D image reconstruction unit 300 may globally fit the primary globally fitted standard mesh model to a 3D volume or point model reconstructed using the multi-view images by controlling key frame parameters required to control the NURBS surfaces. Further, the 3D image reconstruction unit 300 may perform fine local fitting by setting cut-planes at regular intervals between joints in the reconstructed 3D volume or point model, by detecting feature points and representative feature points while detecting corresponding feature points and representative feature points even from the appearance of the standard mesh model in the same manner, and by calculating an optimization function between the corresponding feature points.

Furthermore, the 3D image reconstruction unit 300 may perform the texturing procedure of coloring the corresponding vertices of the multi-view image information on the standard mesh model on which fine local fitting has been performed, thus generating the final unique mesh model of the dynamic object.

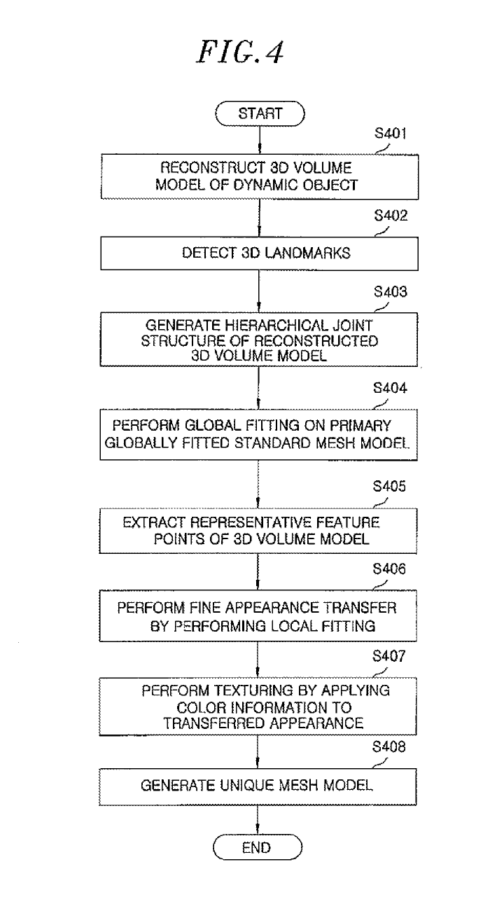

The operating procedure of the 3D image reconstruction unit 300 will be described below with reference to FIG. 4.

FIG. 4 is a flow chart showing the operating procedure of the 3D image reconstruction unit in accordance with an embodiment of the present invention.

As shown in FIG. 4, in step S401, the 3D image reconstruction unit 300 may separate a portion corresponding to an object region from each image of a multi-view image as a foreground, and can reconstruct the geometric shape of the 3D appearance into a 3D volume or point model of the dynamic object, based on a volume defined as voxels or based on object points present in a 3D space, by using foreground region information of the camera and color information in the foreground.

Hereinafter, a description of the reconstruction of the 3D appearance of a multi-view image-based object will focus on the reconstruction of a voxel-based volume.

The reconstructed surface voxels or points have a probability for color consistency (photo-consistency) of multi-view images. For example, voxels having lower photo-consistency depending on the location of a multi-view camera 100 and the pose of the object may have a low probability value.

The 3D image reconstruction unit 300 extracts feature points, such as principal connecting points and vertices for respective regions, based on the color and silhouette information of the multi-view images and information about voxels having higher photo-consistency among the reconstructed surface voxels, detects connectivity between the surface voxels and right/non-rigid properties of the surface voxels, and then divides regions.

Further, in step S402, the 3D image reconstruction unit 300 may detect 3D landmarks corresponding to the extracted feature points (joining points and vertices) and rigid/non-rigid boundaries from the reconstructed 3D volume model. Furthermore, in step S403, the 3D image reconstruction unit 300 may generate sections based on normal vectors of the surface voxels having a higher probability value for photo-consistency in the principal regions of the volume model, and may be capable of generating a hierarchical joint structure of the reconstructed 3D volume model that maintains the characteristics of the hierarchical skeletal structure of the standard mesh model using the skeleton information of the volume model generated by connecting center points of the generated sections for respective regions, the landmark information of the detected principal joining portions, and information about the positions and directions of joints based on the metrological information of the standard mesh model.

The skeleton information of the 3D volume model reconstructed by the 3D image reconstruction unit 300 obtains skeleton information using a method of skeletonizing the 3D volume model using distance conversion or the like, as well as the method using sections generated based on the normal vectors of the voxels, thus generating the skeleton information by mutually correcting the section-based skeleton information and the skeletonization-based skeleton information.

Next, in step S404, the 3D image reconstruction unit 300 may align the skeletal structures by adjusting the position and direction parameters of joints of the primary globally fitted standard mesh model corresponding to the respective joints in the skeletal structure of the 3D volume model. A ratio corresponding to a difference between the lengths of the joints, which has occurred in the alignment procedure, may be applied to the positions and direction parameters of key sections located between the joints of the primary globally fitted standard mesh model, so that scaling and fitting may be performed on each joint of the primary globally fitted standard mesh model, thus enabling global fitting to be performed.

In this way, the standard mesh model that has been globally fitted via global fitting incorporates the characteristics of the validated hierarchical joint structure of the primary globally fitted standard mesh model, and the global scaling of the standard mesh model may be performed by performing sequential scaling on all joints, thus enabling the size of the model to approximate that of the volume model. Further, the standard mesh model not only may incorporate the local scale properties of the model by performing fitting on each region of the human body between individual joints, but also may incorporate the detailed properties of respective regions by fitting the position and direction parameters of key section curves constituting the appearance surface of the model bound between the joints.

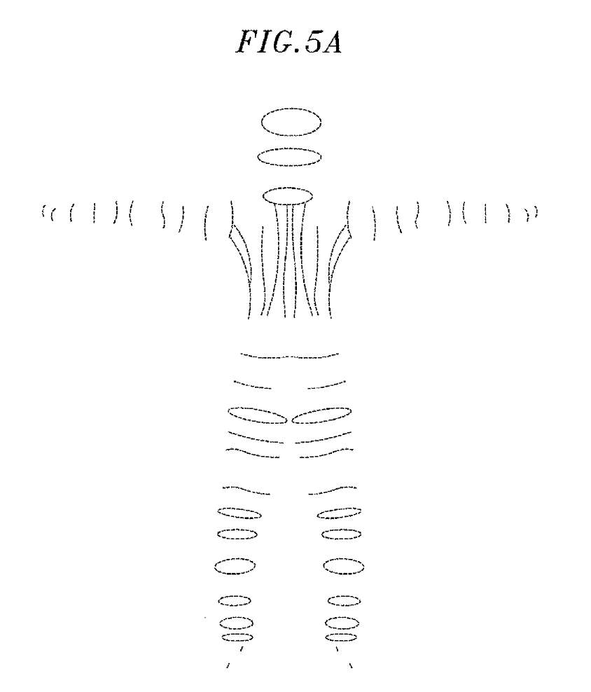

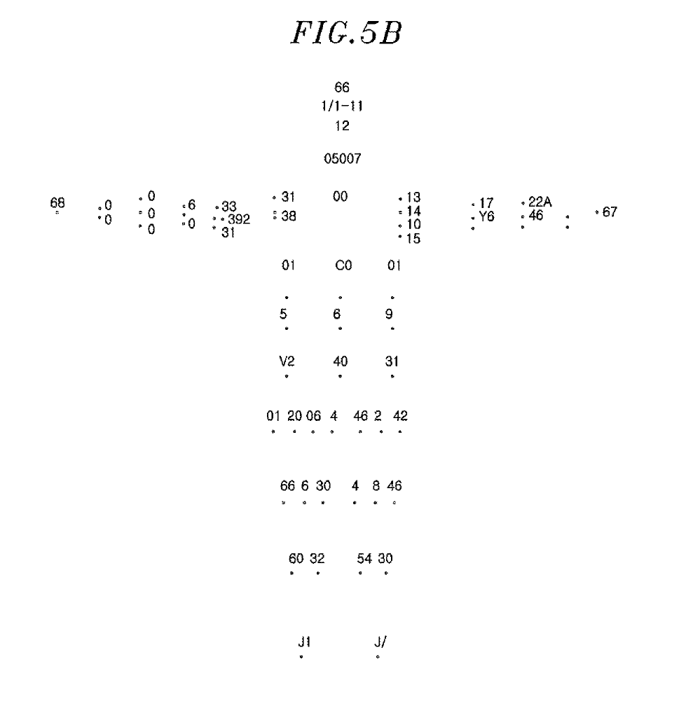

Further, in step S405, the 3D image reconstruction unit 300 may extract feature points at regular intervals desirably representing the appearance of the 3D volume model on the basis of information about individual joints and the regions of the object based on the joints in the skeletal structure of the 3D volume model. Further, the 3D image reconstruction unit 300 may extract, from the extracted feature points, representative feature points of the 3D volume model, which may desirably represent the properties of the respective regions of the object and may be present at locations corresponding to those of the representative feature points extracted from the primary globally fitted standard mesh model. For example, as shown in FIGS. 5A and 5B, feature points desirably representing the appearance of the 3D volume model may be extracted. Thereafter, from the feature points, feature points corresponding to the representative feature points extracted from the primary globally fitted standard mesh model, may be extracted and set as the representative feature points of the 3D volume model.

Next, in step S406, the 3D image reconstruction unit 300 may perform fine appearance transfer on the transformed standard mesh model by performing local fitting on the basis of the representative features points of the standard mesh model, which has been transformed by global scaling and fitting on the primary globally fitted standard mesh model, i.e., the primary globally fitted standard mesh model on which the global fitting has been performed, and the representative feature points of the 3D volume model detected by a representative point detection unit. For the purpose of fine appearance transfer, displacements between the appearance of the reconstructed 3D volume model and the NURBS surfaces of the transformed standard mesh model may be determined by optimizing an error function including an error in distance between the vertices of the representative feature points detected from the appearance of the reconstructed 3D volume model and the vertices of the transformed standard mesh model, an error in the distance between the representative feature points of the reconstructed 3D volume model and the representative feature points of the standard mesh model, and an error in smoothness indicating how much the transformed standard mesh model maintains the initial mesh geometry of the standard mesh model before being transformed. A weighted sum between the displacements determined in this way and the base parameters of key sections, constituting the appearance NURBS surface that have been transformed via the global fitting of the standard mesh model, may be calculated, so that fine appearance transfer may be performed.

With respect to pieces of joint information transferred together with the appearance structure of the mesh, the properties of a specific region of the object may be finally adjusted by error optimization between the volume model and the transformed standard mesh model so that the properties may be suitable for the object using the transferred mesh structure, thus enabling the appearance of the object to be realistically and finely transferred in consideration of the muscular features of the respective regions of the object. This enables the properties of the object for individual principal regions to be emphasized compared to a simple surface-based parametric control scheme and also enables more realistic and natural formation to be realized.

Thereafter, the 3D image reconstruction unit 300 may perform texturing by applying color information to the transferred appearance, i.e., the result of performing local fitting, in step S407, and then the NURBS-based rigged unique mesh model of the dynamic object may be generated in step S408. That is, the color information of each multi-view image is assigned to the locations corresponding to the geometric information of the transferred standard mesh model based on the color map of the standard mesh model, so that the NURBS-based rigged unique mesh model of the dynamic object may be generated.

As described above, the standard mesh model may be very finely transferred into the appearance of the dynamic object via the global and local fitting procedures, and the unique mesh model of the dynamic object that is rigged and skinned using the joint-NURBS surface-vertex structure of the standard mesh model may be generated.

The skinning and skin data output unit 400 may generate and output a final unique mesh model and data required to perform animation on the basis of the NURBS-based unique mesh model of the dynamic object and at least two pieces of operation information about the dynamic object.

That is, the skinning and skin data output unit 400 may arrange joints, which re-represent appearance information close to the appearance information of a transformed unique mesh model, and a suitable number of virtual joints at suitable locations between the individual joints while transforming the NURBS-based rigged/skinned unique mesh model of the dynamic object depending on various types of input operation information about the dynamic object, and then binds the joints to vertices using predetermined weights. Accordingly, the skinning and skin data output unit 400 may generate the final unique mesh model and data required to perform animation using a new adaptive virtual joint-based linear blending skinning technique that overcomes the disadvantage of efficiency being deteriorated in game consoles, commercial software (S/W), mobile display devices, and the like due to problems such as insufficiency of the real-time properties and compatibility of a NURBS-based rigging/skinning animation engine.

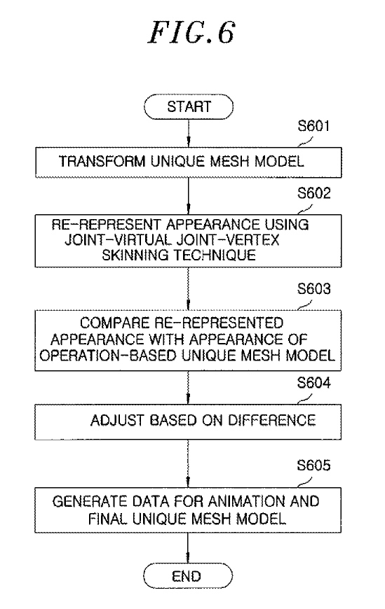

A procedure in which the skinning and skin data output unit 400 generates the final unique mesh model and the data required for animation will be described in detail with reference to FIG. 6.

FIG. 6 is a flow chart showing the operating procedure of the skin data output unit in accordance with an embodiment of the present invention.

Before a description is made, it is noted that the NURBS-based rigged/skinned unique mesh model of a dynamic object means the unique mesh model of a dynamic object enabling animation, which has been automatically transferred by performing global and local fitting on the appearance and joint-NURBS surface-vertex binding structure of a standard mesh model enabling realistic and natural animation. However, a NURBS-based rigging/skinning engine has limitations in that it guarantees neither real-time properties in devices, such as game consoles, low-specification mobile display devices, smart Television (TV), and smart phones, nor compatibility with commercial S/W such as Maya or 3DSMax required to widely use the generated model.

Therefore, as shown in FIG. 6, in an embodiment of the present invention, virtual joints are set between individual joints so that transformed appearance information per operation is re-represented most realistically while a NURBS-based rigged/skinned unique mesh model is transformed in various operations in step S601 by employing a linear blending skinning technique. Here, the linear blending skinning technique guarantees real-time properties and also compatibility with a commercial engine while reproducing realistic and natural appearance transformation properties of a NURBS-based rigging/skinning technique without change or in an improved manner. The number and position of the virtual joints are changed in an adaptive manner to suit each operation or each object, so that a more realistic and natural appearance may be represented. That is, in step S602, the skinning and skin data output unit 400 may generate the re-represented appearance of the joint-virtual joint-vertex skinning technique by performing the joint-virtual joint-vertex skinning technique based on the transformed appearance information of the unique mesh model.

Next, in step S603, the skinning and skin data output unit 400 may compare the re-represented appearance of the joint-virtual joint-vertex skinning technique with the appearance of the NURBS-based rigged/skinned unique mesh model based on various types of operation information.

The skinning and skin data output unit 400 may adjust the position and number of virtual joints for a portion having a difference as a result of the comparison, and adjusts weights between the virtual joints and vertices in step S604, thus enabling the maximally similar appearance to be represented. After information about weights between joints and vertices of a linear blending skinning technique having adaptive virtual joints of the joint-virtual joint-vertex technique, which obtains the maximally similar appearance in this way, has been extracted, data required to perform animation and the final unique mesh model are generated from the weight information, and are then output in step S605. Such weight information can be output in a form in which it is loaded by commercial S/W.

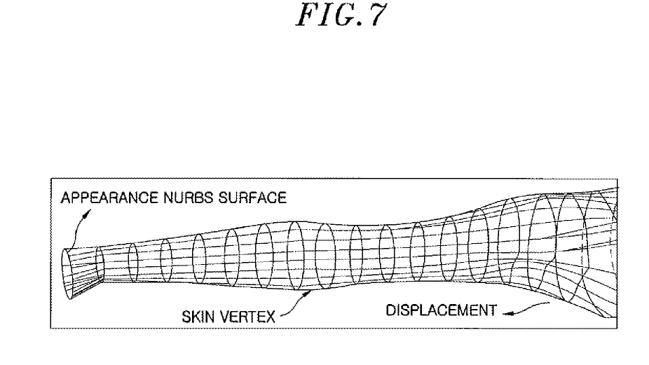

Meanwhile, the appearance NURBS surface of the standard mesh model, skin vertices indicative of the appearance of the model, and a displacement between the NURBS surface and the appearance according to an embodiment of the present invention will be described with reference to FIG. 7.

FIG. 7 is a diagram showing the appearance NURBS surface of a standard mesh model, skin vertices indicative of the appearance of the model, and a displacement between the NURBS surface and the appearance in accordance with the present invention.

As shown in FIG. 7, the appearance NURBS surface is globally fitted to the appearance of a dynamic object by controlling parameters constituting the appearance NURBS surface of the standard mesh model to reconstruct the appearance and motions of the dynamic object. Thereafter, for a difference between the NURBS surface and the appearance of the dynamic object, a displacement is determined for each frame via an error optimization procedure based on feature points and representative feature points, so that even a fine variation in the appearance caused by motions between objects or the motion of a single object may be realistically represented. This means that even a fine variation in skin such as muscles, wrinkles, and folding, can be represented.

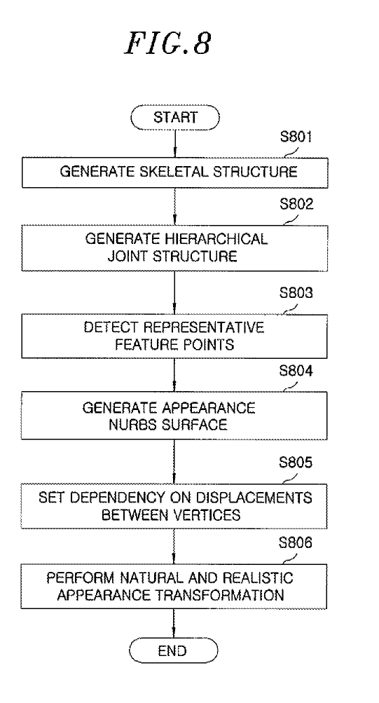

Meanwhile, in an embodiment of the present invention, a standard mesh model input to the image capturing unit 200 is implemented as an appearance NURBS-based standard mesh model. The procedure of generating the appearance NURBS-based standard mesh model will be described with reference to FIG. 8.

FIG. 8 is a flow chart showing the procedure of generating an appearance NURBS surface-based standard mesh model for transferring a mesh model having a skeletal structure that enables shape transformation and animation.

As shown in FIG. 8, a skeletal structure may be generated using given scan data or in an existing 3D mesh object model in step S801, and a hierarchical joint structure having a total of n joints may be generated using the spine of the trunk as a root and using principal joining parts for respective regions (regions of shoulders, wrists, pelvis, and ankles) as sub-roots in step S802.

Next, in step S803, representative feature points may be extracted from locations between the generated joints at which the appearance of the model may be desirably represented. In step S804, sections may be set at locations where the appearance of the model can be desirably represented, a center position may be calculated from a set of vertices of the mesh model present on each section, and 1 number of vertices present at regular intervals around the center position are found and set as key vertices of the section, so that B-spline interpolation is performed on the key vertices to generate key section curves, and the generated key section curves may be interpolated for respective regions of the object, and then appearance NURBS surfaces may be generated.

In step S805, a dependency on displacements between the generated NURBS surfaces and the individual vertices of the input mesh model may be set up. In step S806, an appearance NURBS surface-based standard mesh model generated in this way may transform the appearance of the model naturally and realistically using u direction curves generated in such a way as to perform B-spline interpolation on key vertices corresponding to each of the key section curves as edit points, using a uv-map generated in a v direction, using the height parameters of the knot vectors of the muscle surfaces of each region when a specific pose, e.g., a folded, swollen or projected pose, may be taken, and using a weighted-sum between the displacements of key vertices.

The image capturing unit 200 is a means for capturing a dynamic object that is a target to be reconstructed based on images, and may be, e.g., a camera. That is, the image capturing unit 200 may capture a dynamic object, detect silhouette information from a front view image obtained by capturing the dynamic object, and may provide the silhouette information to the 3D image reconstruction unit 300.

The 3D image reconstruction unit 300 may reconstruct a volume model using the silhouette information, and may finely fit the skeletal structure and appearance of a globally fitted standard mesh model to the reconstructed volume model, thus transferring the skeletal structure and the appearance. That is, the 3D image reconstruction unit 300 may detect the positions of principal joints characterizing the motions of the dynamic object based on the silhouette information, generate a standard mesh model composed of skeleton-based surfaces enabling the facilitation of shape transformation and animation, control the positions, directions and lengths of joints of the standard mesh model, and locations and direction parameters of key sections constituting the appearance surfaces, by using the silhouette and the positions and directions of the detected principal joints as parameters, and then may perform global scaling and fitting. Thereafter, the skeletal structure and the appearance of the globally fitted standard mesh model may be finely fitted to the reconstructed volume model, and then the standard mesh model may be transferred.

Further, the 3D image reconstruction unit 300 may capture the fitted standard mesh model, suitably adjusts the size, location, distance, and the like of the dynamic object using the obtained silhouette information of a previous view as a guideline, and then captures multi-view images of the remaining views.

The 3D image reconstruction unit 300 may reconstruct a volume model based on the silhouette information of the multi-view images, separate the reconstructed volume model into rigid and non-rigid regions, and then may detect the exact positions of joints. Thereafter, the 3D image reconstruction unit 300 may perform fine scaling and fitting on the globally fitted standard mesh model by controlling the positions, directions, and lengths of joints of the standard mesh model, and the location and direction parameters of key sections constituting the appearance surfaces, on the basis of the exact joint positions and directions of the reconstructed volume or point model. Thereafter, perfect appearance transfer may be performed by controlling knot vector parameters on virtual NURBS curves of the appearance surfaces of the standard mesh model, and the radius and displacement parameters of the appearance surfaces so that an error between the multi-view image information about the dynamic object and image information on which the globally fitted standard mesh model is projected may be minimized. In this case, in order to control displacement parameters between surfaces approximating the appearance and the actual appearance, feature points based on the joint positions of the volume or point model reconstructed from the multi-view images may be extracted, and representative feature points that represent the feature points may be selected from among the feature points. Accordingly, the appearance of the standard mesh model may be transferred so that it is maximally consistent with the appearance of the dynamic object by optimizing an error function composed of an error in the distance between the corresponding representative feature points on the standard mesh model, an error in the distance between the feature points detected from the appearance of the reconstructed volume model and the vertices of the transformed standard mesh model, and smoothness error indicating how much the transformed standard mesh model maintains the initial mesh geometry of the standard mesh model before being transformed.

The skinning and skin data output unit 400 may output skinning information re-representing a joint-surface-vertex relation of the transferred standard mesh model by a joint-vertex relation including virtual joints, a skeletal structure such as skinned joints and the number and positions of the virtual joints, and weight information such as binding parameters between the individual joints and vertices.

Further, an animation structure having the joint-surface-vertex binding relation of the standard mesh model may be skinned to a joint-vertex binding relation having adaptive virtual joints based on the appearance-transferred model. Accordingly, the present invention may generate a skinning model that enables real-time animation to be realized even on game consoles or other mobile devices while emphasizing the natural and realistic appearance transformation properties of the standard mesh model.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for reconstructing appearance of a dynamic object and automatically skinning the dynamic object, comprising:
an image capturing unit configured to generate a multi-view image and multi-view silhouette information of a dynamic object and a primary globally fitted standard mesh model, based on images obtained by capturing the dynamic object and a standard mesh model;
a three-dimensional (3D) image reconstruction unit configured to perform global and local fitting on the primary globally fitted standard mesh model based on the multi-view image and the multi-view silhouette information of the dynamic object, and then generate a Non Uniform Rational B-Spline (NURBS)-based unique mesh model of the dynamic object; and
a data output unit configured to generate and output a final unique mesh model and animation data based on the NURBS-based unique mesh model of the dynamic object and at least two pieces of operation information about the dynamic object.

2. The apparatus of claim 1, wherein the image capturing unit generates the multi-view image covering a circumference of the dynamic object, the silhouette information about the multi-view image, and the primary globally fitted standard mesh model using a method of extracting silhouette information of a front view based on a front view image of the dynamic object captured by a camera, performing global fitting on the standard mesh model based on the silhouette information of the front view, receiving an image of a subsequent view by changing a capturing angle of the camera, extracting silhouette information of the subsequent view, and performing global re-fitting on the globally fitted standard mesh model based on the silhouette information of the subsequent view.

3. The apparatus of claim 2, wherein the image capturing unit controls the capturing angle of the camera such that the capturing angle of the camera is changed at intervals of 90°.

4. The apparatus of claim 2, wherein the primary globally fitted standard mesh model is a standard mesh model fitted to silhouette information extracted from front and side view images of the multi-view image.

5. The apparatus of claim 1, wherein the 3D image reconstruction unit separates a portion corresponding to an object region from each image of the multi-view image as a foreground, reconstructs a geometric shape of a 3D appearance of the dynamic object into a 3D volume model or point model of the dynamic object based on a volume defined as voxels or based on points of the dynamic object present in a 3D space, using foreground region information of the camera and color information in the foreground, and generates a NURBS-based rigged unique mesh model of the dynamic object using the reconstructed 3D volume model or point model.

6. The apparatus of claim 5, wherein the 3D image reconstruction unit is configured to:
detect 3D landmarks from the reconstructed 3D volume model, and generate a hierarchical joint structure of the reconstructed 3D volume model;
perform global fitting on the primary globally fitted standard mesh model by performing scaling and fitting on each joint using the hierarchical joint structure of the reconstructed 3D volume model and parameters of the primary globally fitted standard mesh model;
extract feature points of the 3D volume model using the hierarchical joint structure of the reconstructed 3D volume model, and extract representative feature points of the 3D volume model using representative feature points of the primary globally fitted standard mesh model and the extracted feature points;
perform local fitting on the primary globally fitted standard mesh model, on which the global fitting has been performed, using the representative feature points of the primary globally fitted standard mesh model, on which the global fitting has been performed, and the representative feature points of the 3D volume model, thus transferring the appearance; and
generate a NURBS-based rigged unique mesh model of the dynamic object by applying color information to a result of the appearance transfer.

7. The apparatus of claim 6, wherein the 3D image reconstruction unit extracts features points for respective regions based on about color and silhouette information in the multi-view image and information about surface voxels having photo-consistency equal to or greater than a preset value, among surface voxels of the reconstructed 3D volume model, separate regions using connectivity between the surface voxels and rigid/non-rigid properties of the surface voxels, and then detects 3D landmarks corresponding to the extracted feature points and rigid/non-rigid boundaries.

8. The apparatus of claim 6, wherein the 3D image reconstruction unit generates the hierarchical joint structure using sections generated based on normal vectors of voxels within the reconstructed 3D volume model or generates the hierarchical joint structure using skeleton information obtained by skeletonizing the 3D volume model based on distance conversion of the 3D volume model and skeleton information obtained using the sections.

9. The apparatus of claim 1, wherein the data output unit transforms the NURBS-based unique mesh model of the dynamic object based on the operation information, re-represents transformed appearance information using a joint-virtual joint-vertex skinning technique, calculates joint-virtual joint-vertex skinning information by comparing the transformed appearance information with the re-represented appearance information for each piece of operation information, and then generates the animation data and the final unique mesh model using the joint-virtual joint-vertex skinning information.

10. A method for reconstructing appearance of a dynamic object and automatically skinning the dynamic object, comprising:
generating a multi-view image and multi-view silhouette information of a dynamic object and a primary globally fitted standard mesh model, based on images obtained by capturing the dynamic object and a standard mesh model;
performing global and local fitting on the primary globally fitted standard mesh model based on the multi-view image and the multi-view silhouette information of the dynamic object, and then generating a Non Uniform Rational B-Spline (NURBS)-based unique mesh model of the dynamic object; and
generating a final unique mesh model and animation data based on the NURBS-based unique mesh model of the dynamic object and at least two pieces of operation information about the dynamic object.

11. The method of claim 10, wherein said generating the primary globally fitted standard mesh model comprises:
extracting silhouette information of a front view based on a front view image of the dynamic object captured by a camera, and performing global fitting on the standard mesh model based on the silhouette information of the front view; and
receiving an image of a subsequent view by changing a capturing angle of the camera;
extracting silhouette information of the subsequent view, and performing global re-fitting on the globally fitted standard mesh model based on the silhouette information of the subsequent view,
wherein the operations are repeatedly performed to generate the multi-view image covering a circumference of the dynamic object, the silhouette information about the multi-view image, and the primary globally fitted standard mesh model.

12. The method of claim 11, wherein said receiving the image of the subsequent view is configured to change a capturing angle of the camera by 90° and then receive the image of the subsequent view.

13. The method of claim 11, wherein the primary globally fitted standard mesh model is a standard mesh model fitted to silhouette information extracted from front and side view images of the multi-view image.

14. The method of claim 10, wherein said generating the NURBS-based unique mesh model of the dynamic object comprises:
reconstructing a 3D volume model or point model of the dynamic object using the multi-view image; and
generating a NURBS-based rigged unique mesh model of the dynamic object using the reconstructed 3D volume model or point model.

15. The method of claim 14, wherein said generating the NURBS-based unique mesh model of the dynamic object comprises:
detecting 3D landmarks from the reconstructed 3D volume model, and generating a hierarchical joint structure of the reconstructed 3D volume model;
performing global fitting on the primary globally fitted standard mesh model by performing scaling and fitting on each joint using the hierarchical joint structure of the reconstructed 3D volume model and parameters of the primary globally fitted standard mesh model;
extracting feature points of the 3D volume model using the hierarchical joint structure of the reconstructed 3D volume model, and extracting representative feature points of the 3D volume model using representative feature points of the primary globally fitted standard mesh model and the extracted feature points;
performing local fitting on the primary globally fitted standard mesh model, on which the global fitting has been performed, using the representative feature points of the primary globally fitted standard mesh model, on which the global fitting has been performed, and the representative feature points of the 3D volume model, thus transferring the appearance; and
generating a NURBS-based rigged unique mesh model of the dynamic object by applying color information to a result of the appearance transfer.

16. The method of claim 15, wherein said generating the hierarchical joint structure comprises:
extracting features points for respective regions based on color and silhouette information in the multi-view image and information about surface voxels having photo-consistency equal to or greater than a preset value, among surface voxels of the reconstructed 3D volume model; and
separating regions using connectivity between the surface voxels and rigid/non-rigid properties of the surface voxels, and then detecting 3D landmarks corresponding to the extracted feature points and rigid/non-rigid boundaries.

17. The method of claim 15, wherein said generating the hierarchical joint structure is configured to generate the hierarchical joint structure using sections generated based on normal vectors of voxels within the reconstructed 3D volume model or generate the hierarchical joint structure using skeleton information obtained by skeletonizing the 3D volume model based on distance conversion of the 3D volume model and skeleton information obtained using the sections.

18. The method of claim 10, wherein said generating the final unique mesh model and the animation data comprises:
transforming the NURBS-based unique mesh model of the dynamic object based on the operation information;
re-representing transformed appearance information using a joint-virtual joint-vertex skinning technique;
extracting a difference between results of the re-representation and results transformed based on the operation information via a comparison between the results; and
generating the animation data and the final unique mesh model based on the difference.
